(19) United States
(12) Patent Application Publication
(10) Pub. No.: US 2025/0083740 A1
(43) Pub. Date: Mar. 13, 2025

(54) HYDRAULIC ARRANGEMENT AND UTILITY VEHICLE

(71) Applicant: DEERE & COMPANY, MOLINE, IL (US)

(72) Inventors: MANUEL BILLICH, DORNSTADT (DE); MICHAEL MEID, WAGHAEUSEL (DE)

(21) Appl. No.: 18/812,028

(22) Filed: Aug. 22, 2024

(30) Foreign Application Priority Data
Sep. 13, 2023 (DE) 102023124710.7
Sep. 13, 2023 (DE) 102023124711.5

(51) Int. Cl. B62D 5/32; B60T 17/22

(52) U.S. Cl. CPC B62D 5/32; B60T 17/221; B60T 2270/413

(57) ABSTRACT

A hydraulic arrangement for a utility vehicle. In one implementation, the arrangement may include a hydraulic displacement pump and a supply connection as an interface for supplying hydraulic consumers, a displacement control unit dependent on an output pressure of the displacement pump for displacing the displacement pump, a hydraulic auxiliary pump and an auxiliary supply connection as an interface for alternatively supplying at least some of the consumers, and a hydraulic valve unit hydraulically arranged in a throughflow path between a pump output of the displacement pump and the supply connection. The hydraulic valve unit may have a first switching position in which the pump output is hydraulically connected to the supply connection and hydraulically separated from an output of the auxiliary pump, and a second switching position in which the pump output is hydraulically separated from the supply connection and hydraulically connected to the output of the auxiliary pump.

### CROSS-REFERENCE TO RELATED APPLICATIONS

This application claims priority to German Patent Application No. 102023124710.7, filed on Sep. 13, 2023, and to German Patent Application No. 102023124711.5, filed on Sep. 13, 2023, which are hereby incorporated by reference herein.

### TECHNICAL FIELD

The present disclosure relates generally to a hydraulic arrangement for a utility vehicle and to a utility vehicle having such a hydraulic arrangement.

### BACKGROUND

A hydraulic arrangement for a utility vehicle may include a hydraulic displacement pump for supplying hydraulic consumers of the utility vehicle.

### SUMMARY

In tractors, variable displacement pumps may be used for supplying vehicle-internal or external hydraulic consumers (for example, in attachments). The displacement pump is driven, e.g., via a gear mechanism, by the drive motor of the utility vehicle or tractor. During a starting operation of the drive motor, the displacement control unit of the displacement pump is in many cases adjusted to a maximum conveying position, that is to say, for conveying a maximum hydraulic quantity. This requires a correspondingly high drive power of the drive motor. A cold start of the utility vehicle can additionally cause the power consumption of the displacement pump to increase as a result of the increased viscosity of the hydraulic medium.

A potential advantage of at least some implementations of the present disclosure is to provide a hydraulic arrangement and a utility vehicle which reduces the power required for the displacement pump when the utility vehicle is started.

This potential advantage may be achieved by a hydraulic arrangement having the features of one or more embodiments disclosed herein and by a utility vehicle having the features of one or more embodiments disclosed herein.

Additional embodiments of the hydraulic arrangement according to the disclosure and the utility vehicle according to the disclosure are set out in the one or more embodiments disclosed herein.

There is proposed according to claim 1 a hydraulic arrangement for a utility vehicle which contains a hydraulic displacement pump and a supply connection as an interface for supplying hydraulic consumers. These may be vehicle-internal consumers and where applicable also vehicle-external consumers (for example, in an attachment). The displacement pump is adjustable with respect to the conveying quantity or the volume flow thereof by a displacement control unit which is dependent on an output pressure of the displacement pump and optionally one or more additional physical variables. The hydraulic arrangement further contains a hydraulic auxiliary pump and an auxiliary supply connection as an interface for alternatively supplying at least some of the hydraulic consumers (for example, a steering system and/or a brake system), e.g., in the event of an emergency in which the displacement pump fails. A hydraulic valve unit is arranged in the hydraulic throughflow path between a displacement pump output and the supply connection. It has a plurality of, e.g., two or three, switching positions. In a first switching position of the valve unit, the displacement pump output is hydraulically connected to the supply connection and hydraulically separated from an auxiliary pump output. In a second switching position of the valve unit, the displacement pump output is hydraulically separated from the supply connection and hydraulically connected to the auxiliary pump output.

The pump output or displacement pump output may be a hydraulic output directly at the displacement pump itself or may be in the form of a hydraulic output of a pump unit which contains the displacement pump. Similarly, the auxiliary pump output may also be a hydraulic output directly at the auxiliary pump itself or may be in the form of a hydraulic output of an auxiliary pump unit which contains the auxiliary pump.

In displacement pumps, the conveying quantity or the volume flow of the conveyed hydraulic medium (for example, oil) may be displaced not only by different drive speeds but also at a constant drive speed of the displacement pump. Different parameters are conceivable as manipulated variables, for example, a current hydraulic pressure, e.g., at the displacement pump output and/or at a hydraulic feedback connection, at which a hydraulic feedback pressure of hydraulic consumers is applied. The respective manipulated variable(s) can influence a suitable displacement control unit which adjusts, e.g., continuously adjusts, the displacement pump with respect to the conveying quantity thereof.

The displacement control unit can be adjusted between a conveying position with a maximum conveying quantity and a conveying position with a minimum conveying quantity. In this case, a hydraulic displacement cylinder may be used.

With the hydraulic arrangement according to the disclosure, the potential technical advantage may be achieved of providing in the start phase of the drive motor of the utility vehicle at the pump output of the displacement pump a predetermined desired pressure as the output pressure so that this output pressure brings about a conveying quantity which is as small as desired, e.g., minimal, of the displacement pump by the displacement control unit. The power consumption or the power requirement of the displacement pump can thereby be reduced, whereby the load on the drive motor and the starter motor, which drives it, of the utility vehicle in the start phase is relieved.

This physical state, which is desired in the start phase of the utility vehicle, of the displacement pump is supported by the auxiliary pump and the valve unit. In this case, the valve unit can be actuated in such a manner that it takes up the second switching position thereof, in which the displacement pump output is hydraulically connected to the output of the auxiliary pump and is hydraulically separated from the supply connection. The second switching position forms the prerequisite for a predetermined desired pressure being able to be produced by means of the activated auxiliary pump at the displacement pump output. Consequently, the displacement pump and, as a result, the drive motor and the starter motor of the utility vehicle can be supported in a start phase with low energy losses.

The first switching position of the valve unit is for example the rest position or initial position thereof. The first switching position can for example be activated after the start phase of the utility vehicle has been carried out. The displacement pump can then correctly supply the consumers with hydraulic medium.

The value of the predetermined desired pressure at the pump output is for example defined so that it corresponds at least to a pressure difference at the displacement control unit which brings about a minimal conveying quantity of the displacement pump. This pressure difference (for example, approximately 26 bar) may be referred to as a control pressure difference and is for example a difference between the output pressure at the pump output and a feedback pressure of hydraulic consumers.

A pump drive shaft which drives the displacement pump is for example mechanically connected to an output shaft of the drive motor via a gear mechanism.

During a starting operation of the utility vehicle, the auxiliary pump can be used in order to produce a predetermined desired pressure at the pump output and consequently to maintain the conveying quantity of the displacement pump in a reduced or minimal state in the start phase. Conventionally required drive power during the starting operation is thereby reduced or avoided so that, for example in the event of a cold start with high viscosity of the hydraulic medium, the load on the displacement pump and the drive motor and the start motor of the utility vehicle is relieved. The start operation of the utility vehicle can be carried out with a substantially lower power requirement, which also supports the technical sequence of a successful cold start.

As one example, the valve unit is in the second switching position thereof with the displacement pump being stopped and the auxiliary pump being driven. It is thereby possible to build up the desired or predetermined output pressure or desired pressure at the displacement pump output without this having to be carried out by the displacement pump itself. This state at the displacement pump output can advantageously be produced directly before the drive motor of the utility vehicle is started so that, during the starting operation of the drive motor of the utility vehicle, the displacement pump has a significantly reduced or minimal power consumption. Power losses of the drive motor and the starter motor during a starting operation of the utility vehicle can thereby be reduced.

The hydraulic arrangement may have at least one of the following states or features with an increasing output pressure at the displacement pump output after reaching or exceeding a predetermined desired pressure:
the valve unit is in a different switching position from the second switching position. This other switching position is for example the first switching position thereof.
The drive of the auxiliary pump is reduced or deactivated. In this case, consideration is given to the fact that the displacement pump has to be supported by the auxiliary pump either not at all or only to a lesser extent after reaching or exceeding the predetermined desired pressure so that a drive energy for the auxiliary pump is accordingly no longer required or is required only to a reduced extent.
The displacement pump is driven. In this case, the hydraulic arrangement can be controlled so that the displacement pump is driven with increasing output pressure after reaching or exceeding the predetermined desired pressure and consequently with a reduced or minimal pump displacement. The displacement pump is for example driven by the starting drive motor.

Apart from the first and second switching positions, the valve unit may also have at least one additional switching position. An additional switching position, which can be referred to as a separation switching position, of the valve unit is configured in such a manner that, when it is activated, the output of the displacement pump is separated from the supply connection and the output of the auxiliary pump.

This separation switching position is advantageously activated when in the second switching position at the output of the displacement pump the predetermined desired pressure has been reached or exceeded. It is thereby also possible with any hydraulic leaks in the hydraulic consumers to ensure with simple technical means that during the activated separation switching position the pressure produced at the output of the displacement pump is maintained. It is thereby possible, for example, during the start phase of the drive motor, to maintain the necessary pressure at the pump output without the auxiliary pump having to be activated in this case.

For example, the valve unit is moved, after the start phase of the drive motor has been carried out, out of the above-mentioned separation switching position into the first switching position thereof, in which the output of the displacement pump is hydraulically connected to the supply connection and consequently the consumers are supplied with hydraulic medium.

In another embodiment, the hydraulic arrangement has in the throughflow path between the output of the auxiliary pump and the auxiliary pump connection a hydraulic auxiliary valve unit having a plurality of switching positions, e.g., two switching positions. In this case, in a first switching position, the output of the auxiliary pump is hydraulically connected to the auxiliary supply connection. In a second switching position, the output of the auxiliary pump is hydraulically separated from the auxiliary supply connection. The first switching position of the auxiliary valve unit is for example the rest position or initial position thereof.

The functionality of the auxiliary valve unit allows the hydraulic connection thereof to the auxiliary supply connection to be separated or to be interrupted when the auxiliary pump is driven by the second switching position of the auxiliary valve unit being activated. The auxiliary valve unit supports with this second switching position an energy-saving operation of the auxiliary pump since, despite any leaks in the region of the hydraulic consumers, no conveying flow or volume flow flows from the auxiliary pump in the direction of the auxiliary supply connection.

For example, the auxiliary valve unit and the valve unit are at least temporarily in the second switching position thereof when the auxiliary pump is driven. With this combination of switching positions, a desired pressure at the output of the displacement pump can be efficiently produced before the drive motor of the utility vehicle is started.

In another combination of the switching positions, the auxiliary valve unit and the valve unit are at least temporarily in the first switching position thereof when the displacement pump is driven. With this combination of switching positions, the supply of the hydraulic consumers can reliably be ensured during and/or after the start phase of the drive motor. Should, in this case, the displacement pump fail, a hydraulic emergency operation for at least some hydraulic consumers, e.g., safety-relevant consumers (for example, brake system and/or steering system), can be ensured without particular technical complexity simply by driving or activating the auxiliary pump.

In another embodiment, the valve unit and/or the auxiliary valve unit can be controlled in order to change the switching position thereof in accordance with sensor signals of a pressure sensor. This pressure sensor is hydraulically for example to the output of the auxiliary pump or the output of the displacement pump. It is thereby possible to detect, in a technically simple and reliable manner, reaching or exceeding the mentioned predetermined desired pressure at the output of the displacement pump. The pressure sensor is connected, for example, to a control unit (e.g., an electronic controller including a processor and memory) which processes the pressure sensor signals and which controls the valve unit and/or the auxiliary valve unit and/or additional valves in the hydraulic arrangement. The control can be carried out in accordance with the pressure sensor signals and/or additional signals or data (for example, speed of the drive motor, bus signals of a control and/or data bus of the utility vehicle).

The valve unit and/or the auxiliary valve unit is, as one example, in the form of a distributing valve with a plurality of switching positions, for example a proportional valve.

In an embodiment, the valve unit has a hydraulic control input which is hydraulically connected to the output of the displacement pump. By means of the control input, a switching position of the valve unit can be changed or activated. In this case, the valve unit has such dimensions with respect to this control that, when the predetermined desired pressure at the displacement pump output is reached or exceeded, the switching position of the valve unit changes. For example, the already-explained separation switching position is then automatically adjusted, in which position the output of the displacement pump is hydraulically separated from the supply connection and from the output of the auxiliary pump.

In order to activate the individual switching positions thereof, the valve unit and/or auxiliary valve unit can be controlled or actuated in a technically reliable manner in different suitable manners. For example, a direct electrical control, e.g., via an electromagnet, is provided. Alternatively, an indirect control via a hydraulic precontrol valve which can be electrically controlled is provided and a hydraulic control pressure is applied to the valve unit or auxiliary valve unit.

The hydraulic precontrol valve has a control pressure connection which is hydraulically connected to a hydraulic control pressure input of the valve unit or the auxiliary valve unit. It is thereby possible to control the valve unit or the auxiliary valve unit by a hydraulic control pressure. In this case, the precontrol valve is configured in such a manner that the control pressure connection in one switching position of the precontrol valve is hydraulically connected to a hydraulic tank and, in another switching position of the precontrol valve, is hydraulically connected to the output of the auxiliary pump. It is thereby possible to use the output pressure of the auxiliary pump in order to change a switching position of the relevant valve unit or auxiliary valve unit during an (e.g., electrical) actuation of the precontrol valve.

The disclosure further relates to a utility vehicle, such as an agricultural or forestry towing vehicle (for example, a tractor or hauling vehicle) or a construction machine, having a drive motor and having a hydraulic arrangement according to any one of claims 1 to 12.

The utility vehicle according to the disclosure has the above-described advantages of the hydraulic arrangement according to the disclosure. The hydraulic arrangement allows an efficient technical operation of the displacement pump before, during and after a starting operation of the drive motor of a utility vehicle. For example, during a cold start, conventional impairments in the start phase of the drive motor can be avoided.

Thus, the hydraulic arrangement allows the displacement pump, the drive motor and the starter motor which drives it to be able to be operated with particularly low energy losses in the event of a cold start with high viscosity of the hydraulic medium. The start operation of the utility vehicle can be carried out with a substantially lower power requirement, which also supports the technical sequence of a successful cold start.

The utility vehicle can have a drive motor for driving the displacement pump which is contained in the hydraulic arrangement.

The auxiliary supply connection is hydraulically connected to a brake system and/or a steering system of the utility vehicle. Consequently, the technical prerequisites for a technically simple-to-produce emergency operation of the brake system and/or steering system are provided by the hydraulic arrangement according to the disclosure being able to be integrated in the utility vehicle in a modular manner and in this case the auxiliary pump being able to be hydraulically connected to the auxiliary supply connection.

This hydraulic connection can be direct or indirect (for example, by interposing the auxiliary valve unit).

The disclosure is explained in greater detail below with reference to the appended drawings. In this case, components which correspond or are comparable with regard to their function are denoted with the same reference numerals.

Other features and aspects will become apparent by consideration of the detailed description, claims, and accompanying drawings.

### BRIEF DESCRIPTION OF THE DRAWINGS

The detailed description of the drawings refers to the accompanying figures.

FIG. 1 shows a schematic illustration of a utility vehicle according to the disclosure.

FIG. 2 shows a hydraulic circuit diagram with the hydraulic arrangement according to a first embodiment of the disclosure.

FIG. 3 shows a hydraulic circuit diagram of the hydraulic arrangement according to another embodiment of the disclosure.

FIG. 4a shows another exemplary embodiment of a valve unit within the hydraulic arrangement according to the disclosure.

FIG. 4b shows another exemplary embodiment of a valve unit within the hydraulic arrangement according to the disclosure.

FIG. 5a shows a first exemplary embodiment of a precontrol valve for controlling the valve unit.

FIG. 5b shows another exemplary embodiment of the precontrol valve.

Like reference numerals are used to indicate like elements throughout the several figures.

### DETAILED DESCRIPTION

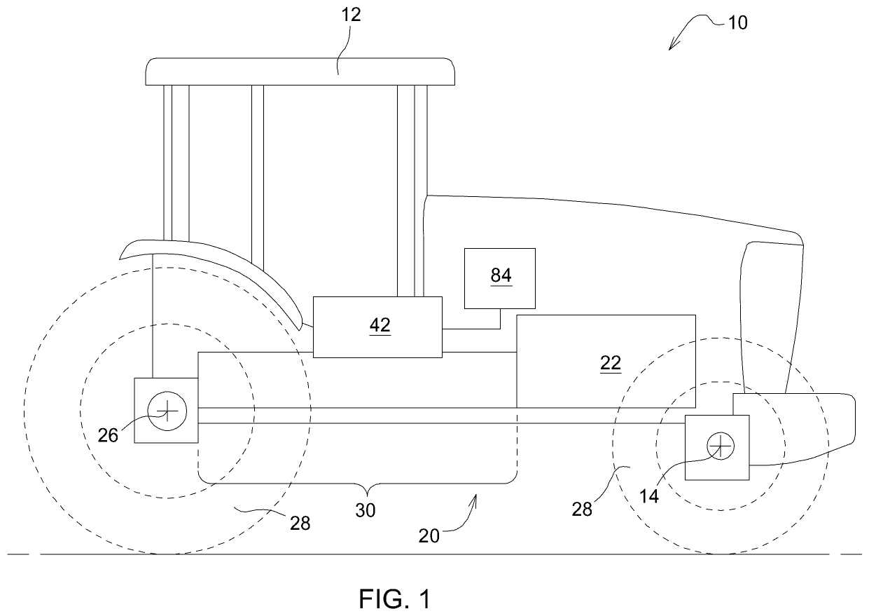

FIG. 1 shows a schematic illustration of an agricultural utility vehicle 10 according to the disclosure, e.g., in the form of a tractor, having a drive train 20. The utility vehicle 10 further comprises a cab 12, a front vehicle axle 14 and a rear vehicle axle 26. The utility vehicle 10 can have one or more ground engaging means in the form of wheels 28. The drive train 20 comprises a drive motor 22 which may be in the form of an internal combustion engine and a gear mechanism structure 30 which may be composed of different individual gear mechanism components.

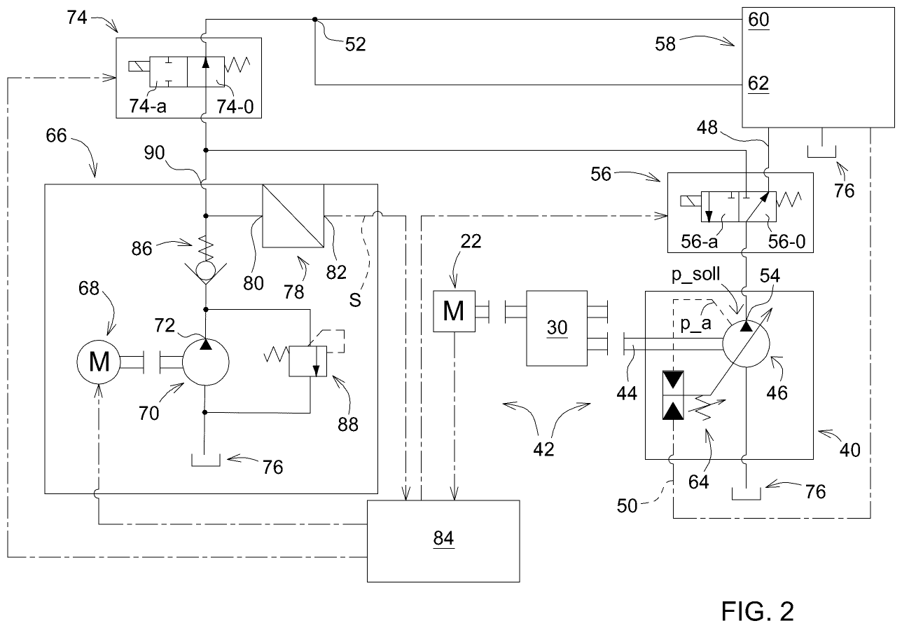

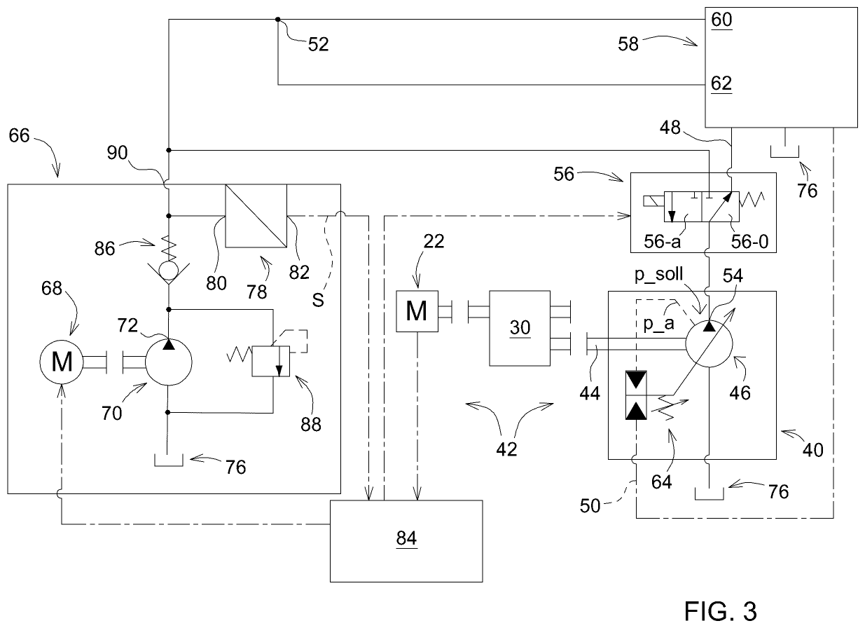

The utility vehicle 10 has a hydraulic arrangement 42 having a pump unit 40. As can be seen in FIGS. 2 and 3, the drive motor 22 can drive the gear mechanism structure 30 which drives a displacement pump 46 of the pump unit 40 via a gear mechanism component and a pump drive shaft 44. The hydraulic arrangement 42 may be integrated in the utility vehicle 10 in a modular manner. A modular installation of the hydraulic arrangement 42 in the utility vehicle 10 can be supported by different hydraulic interfaces. A supply connection 48, a return connection 50 and an auxiliary supply connection 52 can act as such interfaces.

According to FIG. 2, a pump output 54 of the pump unit 40 can be connected to the supply connection 48 via a hydraulic valve unit 56 in order to supply hydraulic consumers 58 of the utility vehicle 10. The consumers 58 include inter alia a steering system 60 and a brake system 62. A displacement control unit 64 for displacing a hydraulic conveying quantity of the displacement pump 46 is dependent on the output pressure p_a thereof and a load report pressure at the feedback connection 50.

The arrangement 42 further comprises an auxiliary pump unit 66 having an auxiliary pump 70 which is driven by an auxiliary pump motor 68 (for example, electric motor). The auxiliary pump output 72 thereof can be hydraulically connected to the auxiliary supply connection 52 via an auxiliary valve unit 74. Via the auxiliary pump unit 66, for example, hydraulic consumers, such as the steering system 60 and the brake system 62, which are important in technical driving terms in the event of a failure of the pump unit 40, can be alternatively supplied in the manner of emergency operation.

The valve unit 56 according to FIG. 2 is in the form of a 3/2-way valve. In the first switching position 56-0 thereof corresponding to the rest position, the pump output 54 is hydraulically connected to the supply connection 48 and hydraulically separated from the auxiliary pump output 72. In the second switching position 56-a, the pump output 54 is hydraulically separated from the supply connection 48 and hydraulically connected to the auxiliary pump output 72.

The auxiliary valve unit 74 according to FIG. 2 is in the form of a 2/2-way valve. In the first switching position 74-0 thereof corresponding to the rest position, the auxiliary pump output 72 is hydraulically connected to the auxiliary supply connection 52. In the second switching position 74-a, the auxiliary pump output 72 is hydraulically separated from the auxiliary supply connection 52.

At the input side, the displacement pump 46 and the auxiliary pump 70 are each connected to a hydraulic tank 76. The hydraulic medium which is conveyed to the consumers 58 flows back into the hydraulic tank 76.

A pressure sensor 78 with a pressure input 80 is connected to the auxiliary pump output 72. Alternatively, the pressure input 80 is connected to the pump output 54. A signal output 82 of the pressure sensor 78 is connected to an electrical control unit 84 (e.g., an electronic controller including a processor and memory) which processes inter alia the output signals or sensor signals S of the pressure sensor 78. In this manner, the control unit 84 can detect the current pressure which is applied to the auxiliary pump output 72 and/or the current output pressure p_a which is applied to the pump output 54. In accordance with this pressure detection, the control unit 84 can inter alia control the valve unit 56 and the auxiliary valve unit 74 in order to change the respective switching position thereof.

In order to support the operation of the hydraulic arrangement 42, a hydraulic non-return valve 86 is interposed between the auxiliary pump output 72 and an output 90 of the auxiliary pump unit 66. Furthermore, the auxiliary pump 70 is combined with a hydraulic pressure valve 88.

FIG. 3 shows another embodiment of the hydraulic arrangement 42. In this embodiment, there is no auxiliary valve unit 74. The output 90 of the auxiliary pump unit 66 is then directly hydraulically connected to the auxiliary supply connection 52.

The above-mentioned hydraulic interfaces—supply connection 48, feedback connection 50, auxiliary supply connection 52—can be arranged for example directly on the respective component (for example, pump unit 40, auxiliary pump unit 66, valve unit 56, auxiliary valve unit 74) of the hydraulic arrangement 42 or be arranged with spacing from the respective component of the hydraulic arrangement 42 by means of a line-like extension.

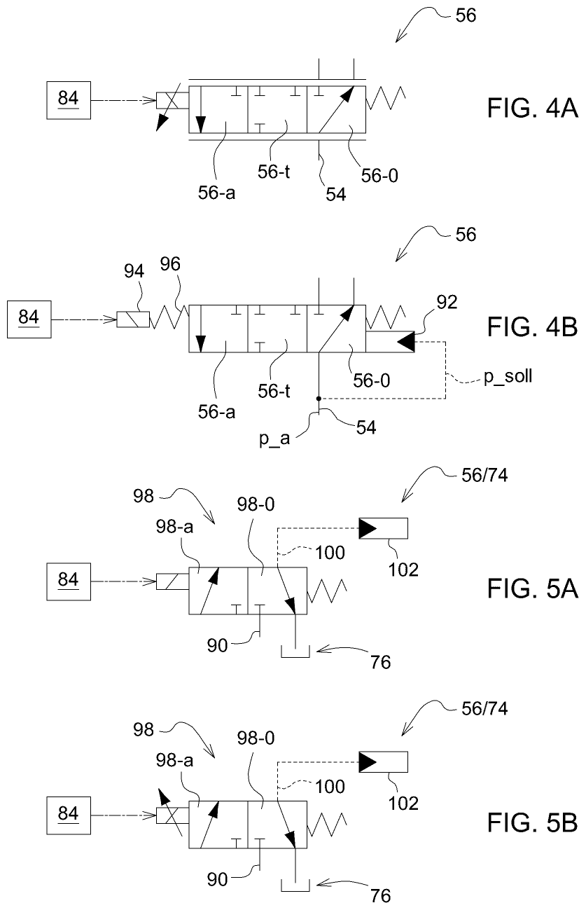

In another embodiment (FIG. 4a), the valve unit 56 further has, in addition to the first and second switching positions 56-0, 56-a, a third switching position in the form of a separation switching position 56-t. In the case of the activated separation switching position 56-t, the pump output 54 of the displacement pump 54 is hydraulically separated from the supply connection 48 and at the same time also hydraulically separated from the auxiliary pump output 72 or from the auxiliary pump unit 66.

The valve unit 56 with the two switching positions 56-0, 56-a and the valve unit 56 with the three switching positions 56-0, 56-a, 56-t may optionally be in the form of a constantly adjustable distributing valve, as illustrated in FIG. 4a.

In another embodiment (FIG. 4b), the valve unit 56 has a control input 92 which is hydraulically connected to the pump output 54 of the displacement pump 46. A specific switching position of the valve unit 56, e.g., the separation switching position 56-t, can thereby automatically be activated by the hydraulic control pressure which is applied to the control input 92. In the embodiment according to FIG. 4a, however, the separation switching position 56-t is activated by the electrical control by means of the control unit 84.

Very generally, the valve unit 56 and the auxiliary valve unit 74 can be electrically controlled directly via the control unit 84 in order to activate another switching position.

In the embodiment according to FIG. 4b, the valve unit 56 has such dimensions and the control thereof can be combined with the hydraulic control input 92 by the control unit 84 so that an activated electromagnet 94 together with a pressure limiting spring 96 retains the valve unit 56 in the second switching position 56-a until the predetermined desired pressure p_soll is reached at the pump output 54. This desired pressure p_soll results in the valve unit 56 being moved into the switching position 56-t via the control input 92.

Alternatively, the valve unit 56 and/or the auxiliary valve unit 74 can each be controlled via an electrically controllable hydraulic precontrol valve 98. The precontrol valve 98 is illustrated in FIG. 5a and FIG. 5b in two possible embodiments. In both embodiments, the precontrol valve 98 is in the form of a distributing valve with two switching positions 98-0, 98-a, wherein it can be constantly adjusted in the embodiment according to FIG. 5b. The switching position 98-0 may be the rest position of the precontrol valve 98. The precontrol valve 98 has a control pressure connection 100 which is hydraulically connected to a hydraulic control pressure input 102 of the valve unit 56 or the auxiliary valve unit 74. The control pressure connection 100 is hydraulically connected to a or the hydraulic tank 76 in the switching position 98-0. In the switching position 98-a, the control pressure connection 100 is hydraulically connected to the auxiliary pump output 72 or the output 90 of the auxiliary pump unit 66.

By means of the hydraulic logic unit described, the start phase of the drive motor 22 can be supported with particularly low energy losses, which affords technical advantages for example in the event of a cold start.

Before the utility vehicle 10 is started, the displacement control unit 64, for example the displacement cylinder thereof, is generally adjusted to a conveying position for a maximum conveying quantity as a result of the pressure relationships at the pump output 54 and at the feedback connection 50. However, one potential advantage of at least some implementations may be to keep the power consumption of the displacement pump 46 lowered in the start phase of the utility vehicle 10 and consequently to adjust the displacement control unit 64, e.g., the displacement cylinder thereof, to a conveying position for a lowered conveying quantity. This potential advantage may be achieved with the hydraulic arrangements 42 according to FIG. 2 and FIG. 3.

In the hydraulic arrangement 42 according to FIG. 2, an intended start of the drive motor 22 by the control unit 84 (for example, via received bus signals of a vehicle bus, such as, for example, ISOBUS, CAN) is detected from the rest positions or first switching positions 56-0, 74-0 of the valve unit 56 and the auxiliary valve unit 74, with the control unit subsequently switching the valve unit 56 and the auxiliary valve unit 74 into the second switching position 56-a, 74-a thereof. Furthermore, the auxiliary pump motor 68 is activated by the control unit 84 so that the auxiliary pump 70 is driven and the output pressure p_a at the pump output 54 increases while the displacement pump 46 is stopped. As soon as the displacement pressure p_a which increases has reached or exceeded a predetermined desired pressure p_soll-depending on the system, for example, approximately 26 bar, the displacement control unit 64 is in the minimal conveying position thereof so that the displacement pump 46 has no power consumption or has a low power consumption. The power consumption of the displacement pump 46 in the start phase of the utility vehicle 10 can thereby be significantly reduced, whereby the load on the drive motor 22 and the starter motor thereof is relieved in the start phase.

Since the output pressure p_a is continuously detected by means of the pressure sensor 78, the control unit 84 can control the hydraulic arrangement 42 in the desired manner after reaching or exceeding the predetermined desired pressure p_soll. For example, after reaching or exceeding the predetermined desired pressure p_soll, the auxiliary pump motor 68 is reduced with respect to the drive speed thereof or switched off. The drive motor 22 is started, wherein after reaching a stable speed the valve unit 56 and the auxiliary valve unit 74 are moved into their respective first switching position 56-0, 74-0 or into the rest position thereof. The valve unit 56 then allows supply of the hydraulic consumers by the displacement pump 46.

The hydraulic arrangement 42 according to FIG. 3 operates unlike the embodiment according to FIG. 2 without the auxiliary valve unit 74 so that the output 90 is hydraulically connected directly to the auxiliary supply connection 52. In the event of an intended start of the drive motor 22, the hydraulic arrangement 42 according to FIG. 3 is controlled in principle the same way as in the variant according to FIG. 2. In this case, the valve unit 56 is initially switched from the rest position or the first switching position 56-0 into the second switching position 56-a thereof. Subsequently, as described with reference to FIG. 2, the auxiliary pump 70 is driven. Should leaks occur at the hydraulic consumers 58, however, the auxiliary pump 70 requires a greater drive power than in the variant according to FIG. 2 in order to reach the predetermined desired pressure p_soll at the pump output 54. Furthermore, during the start phase of the drive motor 22, continued operation of the auxiliary pump 70 may be advantageous in order in the start phase to maintain the necessary hydraulic pressure p_soll at the pump output 54.

Alternatively, in the embodiment according to FIG. 3, the above-mentioned continued operation of the auxiliary pump 70 during the start phase of the drive motor 22 can be avoided by the valve unit 56 being provided with the additional separation switching position 56-t (FIG. 4a, FIG. 4b). After reaching or exceeding the predetermined desired pressure p_soll, the valve unit 56 can then be moved out of the second switching position 56-a initially into the separation switching position 56-t in order to maintain the reached desired pressure p_soll. At a suitable time, for example after the completed start of the drive motor 22, the valve unit 56 is moved by means of the control unit 84 out of the separation switching position 56-t into the rest position or first switching position 56-0 thereof.

As used herein, “e.g.” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and” or “or”) and that are also preceded by the phrase “one or more of” or “at least one of” indicate configurations or arrangements that potentially include individual elements of the list, or any combination thereof. For example, “at least one of A, B, and C” or “at least one of A, B, or C” or “one or more of A, B, and C” or “one or more of A, B, or C” indicates the possibilities of only A, only B, only C, or any combination of two or more of A, B, and C (e.g., A and B; B and C; A and C; or A, B, and C).

The teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A hydraulic arrangement for a utility vehicle, the hydraulic arrangement comprising:
a hydraulic displacement pump and a supply connection as an interface for supplying hydraulic consumers of the utility vehicle;
a displacement control unit which is dependent on an output pressure of the displacement pump for displacing the displacement pump;
a hydraulic auxiliary pump and an auxiliary supply connection as an interface for alternatively supplying at least some of the consumers; and
a hydraulic valve unit which is hydraulically arranged in a throughflow path between a pump output of the displacement pump and the supply connection;
wherein the hydraulic valve unit has a first switching position in which the pump output of the displacement pump is hydraulically connected to the supply connection and hydraulically separated from an output of the auxiliary pump, and a second switching position, in which the pump output of the displacement pump is hydraulically separated from the supply connection and hydraulically connected to the output of the auxiliary pump.

2. The hydraulic arrangement of claim 1, wherein the valve unit is in the second switching position thereof with the displacement pump being stopped and the auxiliary pump being driven.

3. The hydraulic arrangement of claim 2, wherein the hydraulic arrangement has at least one of the following features with an increasing output pressure at the pump output of the displacement pump after reaching or exceeding a predetermined desired pressure:
the valve unit is in a different switching position from the second switching position;
the drive of the auxiliary pump is reduced or deactivated; and
the displacement pump is driven.

4. The hydraulic arrangement of claim 1, wherein the valve unit has a separation switching position, in which the pump output of the displacement pump is hydraulically separated from the supply connection and the output of the auxiliary pump.

5. The hydraulic arrangement of claim 4, wherein the valve unit, after reaching or exceeding a predetermined desired pressure at the pump output of the displacement pump, takes up the separation switching position.

6. The hydraulic arrangement of claim 5, wherein the valve unit takes up the first switching position after the separation switching position.

7. The hydraulic arrangement of claim 1, wherein in an auxiliary throughflow path between the output of the auxiliary pump and the auxiliary supply connection is a hydraulic auxiliary valve unit having a plurality of switching positions, wherein in a first switching position of the plurality of switching positions, the output of the auxiliary pump is hydraulically connected to the auxiliary supply connection, and in a second switching position of the plurality of switching positions, the output of the auxiliary pump is hydraulically separated from the auxiliary supply connection.

8. The hydraulic arrangement of claim 1, wherein at least one of the valve unit or the auxiliary valve unit is at least one of the following:
in the second switching position thereof with the auxiliary pump being driven, or
in the first switching position thereof with the displacement pump being driven.

9. The hydraulic arrangement of claim 1, wherein at least one of the valve unit or the auxiliary valve unit can be controlled in order to change the switching position thereof in accordance with sensor signals of a pressure sensor which is hydraulically connected to the output of the auxiliary pump or the pump output.

10. The hydraulic arrangement of claim 1, wherein the valve unit has a control input which is hydraulically connected to the pump output of the displacement pump.

11. The hydraulic arrangement of claim 1, wherein at least one of the valve unit or the auxiliary valve unit can be electrically controlled directly or can be controlled via an electrically controllable hydraulic precontrol valve.

12. The hydraulic arrangement of claim 11, wherein the hydraulic precontrol valve has a control pressure connection which is hydraulically connected to a hydraulic control pressure input of the valve unit or the auxiliary valve unit, wherein the control pressure connection in one switching position of the precontrol valve is hydraulically connected to a hydraulic tank, and in another switching position of the precontrol valve is hydraulically connected to the output of the auxiliary pump.

13. A utility vehicle, comprising:
a drive motor; and
a hydraulic arrangement including:
a hydraulic displacement pump and a supply connection as an interface for supplying hydraulic consumers of the utility vehicle;
a displacement control unit which is dependent on an output pressure of the displacement pump for displacing the displacement pump;
a hydraulic auxiliary pump and an auxiliary supply connection as an interface for alternatively supplying at least some of the consumers; and
a hydraulic valve unit which is hydraulically arranged in a throughflow path between a pump output of the displacement pump and the supply connection;
wherein the valve unit has a first switching position in which the pump output of the displacement pump is hydraulically connected to the supply connection and hydraulically separated from an output of the auxiliary pump, and a second switching position, in which the pump output of the displacement pump is hydraulically separated from the supply connection and hydraulically connected to the output of the auxiliary pump.

14. The utility vehicle of claim 13, wherein the drive motor is drivingly connected to the displacement pump.

15. The utility vehicle of claim 13, wherein the auxiliary supply connection is hydraulically connected to at least one of a brake system or a steering system of the utility vehicle.
